(19) United States
(12) Patent Application Publication
(10) Pub. No.: US 2026/0276012 A1
(43) Pub. Date: Sep. 17, 2026

(54) PNEUMATIC AUTOMATION DEVICE, MAINTENANCE ASSEMBLY, PNEUMATIC SYSTEM, AND METHOD

(71) Applicant: FESTO SE & CO. KG, Esslingen (DE)

(72) Inventors: Michael WINKLER, Weißbach (DE); Stefan SALLER, Esslingen (DE); Daniel SPIES, Kaisersbach (DE)

(21) Appl. No.: 19/166,809

(22) PCT Filed: Mar. 7, 2024
(86) PCT No.: PCT/EP2024/055987

§ 371 Date: Sep. 18, 2025

(30) Foreign Application Priority Data
Mar. 22, 2023 (DE) 10 2023 107 162.9

(51) Int. Cl. F15B 19/00; F15B 21/041; F15B 21/048; G06N 20/00

(52) U.S. Cl. CPC F15B 19/007; F15B 19/005; F15B 21/041; F15B 21/048; G06N 20/00; F15B 2211/615; F15B 2211/6323; F15B 2211/8855

(57) ABSTRACT

A pneumatic automation device including a guide section for guiding compressed air, and an acceleration sensor vibration-coupled to the guide section for providing an acceleration signal that represents vibrations of the guide section caused by a flow of the compressed air, and a computing unit configured to calculate both a pressure value related to the compressed air and a flow value related to the compressed air based on the acceleration signal and using a machine learning model.

The invention relates to a pneumatic automation device comprising a guide section for guiding compressed air.

### BACKGROUND

WO 2021/148268 A1 relates to a device for identifying and/or detecting the condition of an air filter.

DE 10 2018 208 880 A1 relates to a method for detecting a condition of at least one filter element.

DE 10 2018 133 316 B4 relates to a method for operating a field device in automation technology.

DE 10 2020 204 137 A1 relates to a device for detecting the condition of a filter means.

DE 10 2018 212 097 B4 relates to a field device for detecting a process variable, which is designed in particular as a level measuring device for detecting the level of a medium.

### SUMMARY

It is an object of the invention to create an easily realizable way of determining a pressure value related to compressed air and a flow value related to compressed air using the pneumatic automation device.

The object is solved by the pneumatic automation device according to claim 1. The pneumatic automation device comprises an acceleration sensor vibration-coupled to the guide section for providing an acceleration signal that represents vibrations of the guide section caused by a flow of compressed air. The pneumatic automation device further comprises a computing unit that is configured to calculate, on the basis of the acceleration signal and using a machine learning model, both a pressure value related to the compressed air and a flow value related to the compressed air.

Conventionally, two sensors are required to determine the pressure value and the flow value: a pressure sensor for determining the pressure value and a flow sensor for determining the flow value. According to the invention, both the pressure value and the flow value can be determined with a single sensor-the acceleration sensor.

Consequently, fewer sensors are required, making the pneumatic automation device easier to manufacture.

Advantageous further developments are defined in the dependent claims.

The invention further relates to a maintenance assembly for compressed air treatment of a pneumatic system comprising the pneumatic automation device.

The invention also relates to a pneumatic system comprising a compressed air source, the maintenance assembly, and a pneumatic machine that is pneumatically connected to the compressed air source via the maintenance assembly.

The invention further relates to a method for operating the pneumatic automation device, the maintenance assembly, or the pneumatic system, comprising the steps of: providing the acceleration signal and calculating, using the machine learning model, the pressure value and the flow value based on the acceleration signal.

### BRIEF DESCRIPTION OF THE DRAWINGS

Further exemplary details and exemplary embodiments are explained below with reference to the figures.

FIG. 1 shows a schematic representation of a pneumatic system,

FIG. 2 shows a schematic representation of a pneumatic automation device configured as a filter device,

FIG. 3 a schematic representation of a pneumatic automation device with a guide section configured as a pipe section,

FIG. 4 a schematic representation of a pneumatic automation device with a guide section configured as an angle section,

FIG. 5 a schematic representation of a pneumatic automation device with a guide section configured to be a taper section.

### DETAILED DESCRIPTION

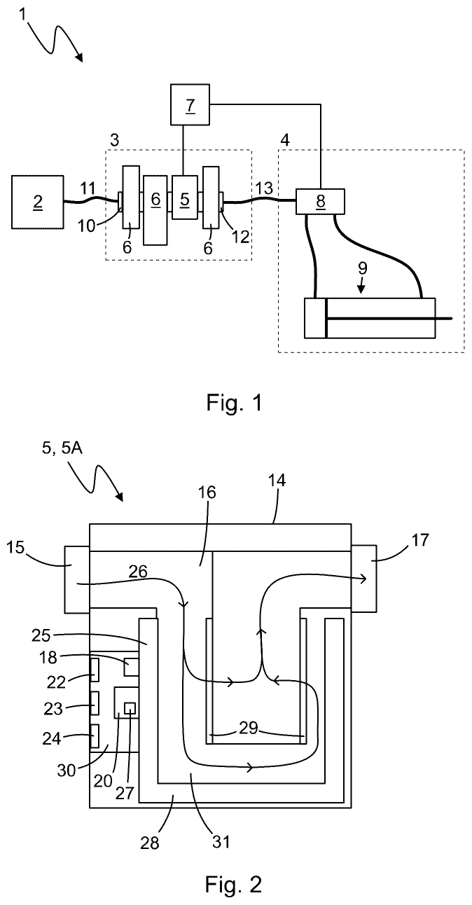

FIG. 1 shows a pneumatic system 1. The pneumatic system 1 is, in particular, an industrial pneumatic system, for example, a pneumatic system for industrial automation. The pneumatic system 1 expediently comprises a compressed air source 2 (for example, a compressor), a maintenance assembly 3 and/or a pneumatic machine 4. The pneumatic machine 4 is pneumatically connected to the compressed air source 2 via the maintenance assembly 3. The compressed air required to operate the pneumatic machine 4 is supplied to the pneumatic machine 4 from the compressed air source 2 via the maintenance assembly 3.

The maintenance assembly 3 can preferably also be provided on its own, i.e., in particular without the other components of the pneumatic system 1. The maintenance assembly 3 is used for compressed air treatment of the pneumatic system 1, in particular for treatment of the supply compressed air of the pneumatic system 1. The maintenance assembly 3 comprises, for example, a pneumatic inlet 10, for example a hose connection, via which the maintenance assembly 3 (in particular via a first hose 11) is connected to the compressed air source 2 and/or a pneumatic outlet 12, for example a hose connection, via which the pneumatic machine 4 (in particular via a second hose 13) is connected to the maintenance assembly 3. The maintenance assembly 3 comprises a pneumatic automation device 5 and preferably at least one functional unit 6 pneumatically connected to the pneumatic automation device 5. For example, there are several functional units 6. Expediently, the functional units 6 and the pneumatic automation device 5 are pneumatically connected in series. In particular, the maintenance assembly 3 comprises, as functional units 6 (or as the automation device 5), a pressure control valve, a switch-on valve, a pressure build-up valve, a compressed air filter, a compressed air dryer, and/or a compressed air oiler.

Optionally, the pneumatic system 1 comprises a control device 7, which comprises, for example, a higher-level controller, in particular a PLC (programmable logic controller). The control device 7 serves, for example, to control and/or diagnose the pneumatic system, in particular the maintenance assembly 3 and/or the pneumatic machine 4. Optionally, the control device 7 can be designed as a cloud server or comprise a cloud server. Furthermore, the control device 7 can be designed as a mobile device (e.g., a smartphone or tablet computer) or comprise a mobile device. Furthermore, the control device 7 can comprise a communication unit that is communicatively connected to the maintenance assembly 3, in particular the pneumatic automation device 5.

The pneumatic machine 4 comprises, for example, a valve device 8 and/or a pneumatic actuator 9. For example, the compressed air supplied by the compressed air source 2 (and conducted via the maintenance assembly 3) is fed to the pneumatic actuator 9 via the valve device 8. Purely by way of example, the pneumatic actuator 9 comprises a pneumatic drive cylinder.

FIGS. 2 to 5 show exemplary embodiments of the pneumatic automation device 5. Unless otherwise stated, the following explanations apply preferably to all embodiments of the pneumatic automation device 5.

The pneumatic automation device 5 can be provided on its own—i.e., in particular without the other components of the maintenance assembly 3 and/or the pneumatic system 1. Optionally, the pneumatic automation device 5 can form the maintenance assembly 3 on its own—i.e., in particular, it can be connected pneumatically between the compressed air source 2 and the pneumatic machine 4.

The pneumatic automation device 5 expediently serves for use in industrial automation. The pneumatic automation device 5 is preferably used in the maintenance assembly 3 (which serves for the compressed air conditioning of the pneumatic system 1).

Optionally, the pneumatic automation device 5 comprises a housing 14, which in particular represents the outer housing of the pneumatic automation device 5. The pneumatic automation device 5 comprises a compressed air inlet 15 (arranged in particular on the housing 14), which is designed, for example, as a hose connection. The pneumatic automation device 5 further comprises a compressed air outlet 17 (arranged preferably on the housing 14), which is designed, for example, as a hose connection. The pneumatic automation device 5 further expediently comprises a compressed air channel 16 (arranged in particular in the housing 14). For example, the compressed air channel 16 runs from the compressed air inlet 15 to the compressed air outlet 17. For example, the pneumatic automation device 5 is connected with its compressed air inlet 15 to a first functional unit 6 of the maintenance assembly 3 and/or is connected with its compressed air outlet 17 to a second functional unit 6 of the maintenance assembly 3.

The pneumatic automation device 5 comprises a guide section 25 for guiding compressed air. For example, the guide section 25 defines the compressed air channel 16 or a section of the compressed air channel 16. For example, the guide section 25 forms at least one channel wall or a section of a channel wall of the compressed air channel 16.

The pneumatic automation device 5 further comprises an acceleration sensor 18, which is preferably vibration-coupled to the guide section 25. The statement that the acceleration sensor 18 is “vibration-coupled” to the guide section 25 means that the acceleration sensor 18 is arranged relative to and/or coupled to the guide section 25 in such a way that mechanical vibrations of the guide section 25 can be detected by the acceleration sensor 18, for example by the mechanical vibrations being transmitted to the acceleration sensor 18. For example, the acceleration sensor 18 is fixed in or on the guide section 25. Preferably, the acceleration sensor 18 is arranged on an outer side of the guide section 25. For example, the guide section 25 has a first side, in particular an inner side, on which the compressed air is guided and which forms, for example, a channel wall of the compressed air channel 16, and a second side, in particular the outer side, which is facing away from the first side and/or on which the compressed air is not guided, and the acceleration sensor 18 is expediently arranged on the second side of the guide section 25.

For example, the pneumatic automation device 5 has an electronic arrangement 30, which preferably comprises the acceleration sensor 18. Optionally, the electronic arrangement comprises a printed circuit board on which the acceleration sensor 18 is arranged and/or an electronic housing in which the acceleration sensor 18 is arranged. For example, the electronic arrangement 30 is arranged on the guide section 25, in particular attached to it, preferably on the second side of the guide section 25, in particular on the outside.

The acceleration sensor 18 serves to provide an acceleration signal. The acceleration signal represents vibrations of the guide section 25 caused by a flow 26 of compressed air, in particular by a flow 26 along the guide section 25. The flow 26 is indicated by arrows in the figures. For example, the flow 26 passes through the compressed air channel 16, in particular from the compressed air inlet 15 to the compressed air outlet 17. The compressed air flowing through the guide section 25 causes the guide section 25 to vibrate, and these vibrations are detected by the acceleration sensor 18 and converted into the acceleration signal.

The pneumatic automation device 5 also comprises a computing unit 20, which is designed, for example, as a microcontroller and is arranged in particular in the housing 14. The computing unit 20 has a machine learning model 27, which is expediently stored in a memory of the computing unit 20. The machine learning model comprises, for example, an artificial neural network.

The computing unit 20 is configured to calculate both a pressure value related to the compressed air and a flow value related to the compressed air on the basis of the acceleration signal and using the machine learning model 27. The pressure value relating to the compressed air preferably describes a pressure of the compressed air in the pneumatic automation device 5, in particular in the compressed air channel 16, for example at a predetermined point in the compressed air channel 16. The pressure value describes, for example, an absolute pressure or a relative pressure of the compressed air in the pneumatic automation device 5. In particular, the pressure value is not a differential pressure value.

Optionally, the computing unit 20 is configured to calculate a differential pressure value related to the compressed air on the basis of the acceleration signal and using the machine learning model. For example, the pressure value is the differential pressure value. Alternatively, the computing unit 20 calculates the differential pressure value in addition to the pressure value. The differential pressure value preferably describes a pressure difference between two pressures of the compressed air in the pneumatic automation device 5, in particular in the compressed air channel 16, for example between a first pressure of the compressed air at a first predetermined location in the compressed air channel 16 and a second pressure of the compressed air at a second predetermined location downstream relative to the first predetermined location with respect to the flow 26.

The flow value relating to the compressed air preferably describes a flow, in particular a mass flow and/or a volume flow, of compressed air in the pneumatic automation device 5, in particular in the compressed air channel 16, for example at a predetermined point in the compressed air channel 16.

The machine learning model 27 can be trained in particular on the basis of training data, for example on the basis of acceleration values, pressure values, and flow values recorded by means of an acceleration sensor, a pressure sensor, a flow sensor (for example, of a training setup), and/or on the basis of simulated training data, in particular a simulated acceleration signal, simulated pressure values, and simulated flow values.

Expediently, the pneumatic automation device 5, in particular the computing unit 20, is configured to calculate the pressure value and the flow value (and optionally the differential pressure value) exclusively on the basis of the acceleration signal. Expediently, the acceleration signal is the only input variable, in particular the only measured variable, on the basis of which the pressure value and the flow value (and optionally the differential pressure value) are calculated. In particular, the pneumatic automation device 5 does not have a pressure sensor and/or a flow sensor, and/or no sensor signal detected by means of a pressure sensor and/or a flow sensor is included in the calculation of the pressure value and the flow value (and optionally the differential pressure value).

Preferably, the machine learning model maps the acceleration signal to the pressure value and the flow value. Optionally, the machine learning model maps the acceleration signal to the pressure value, the flow value, and the differential pressure value.

Expediently, the computing unit 20 is configured to calculate the pressure value, the flow value, and/or the differential pressure value repeatedly, in particular periodically, on the basis of the current acceleration signal by using the machine learning model.

According to a preferred embodiment, the computing unit 20 is designed to calculate a frequency spectrum of the acceleration signal, and the machine learning model maps the frequency spectrum to the pressure value and the flow value (and optionally the differential pressure value). For example, the computing unit 20 is configured to perform a Fourier transform of the acceleration signal in order to calculate the frequency spectrum. The computing unit 20 is configured to calculate the pressure value and the flow value (and optionally the differential pressure value) based on one and the same frequency spectrum using the machine learning model. Expediently, the computing unit 20 is configured to calculate the frequency spectrum repeatedly, in particular periodically, based on the current acceleration signal.

Preferably, the acceleration signal comprises one, two, or three acceleration signal components. For example, each acceleration signal component describes a detected acceleration in relation to a different spatial direction. The computing unit 20 is configured to calculate the pressure value and the flow value (and optionally the differential pressure value) using the machine learning model (in particular exclusively) based on the one acceleration signal component, the two acceleration signal components, or the three acceleration signal components.

Preferably, the computing unit 20 is configured to calculate diagnostic information based on the pressure value and/or the flow value and/or the differential pressure value. The diagnostic information relates, for example, to a condition, such as a wear condition and/or a contamination condition, of the pneumatic automation device 5.

Optionally, the pneumatic automation device 5 comprises a communication interface 22 (arranged in particular on the housing 14), which serves in particular for outputting the pressure value, the flow value, the differential pressure value, and/or the diagnostic information. The communication interface 22 is in particular digital and/or analog. For example, the pneumatic automation device 5 is connected to the control device 7 via the communication interface 22.

Expediently, the pneumatic automation device 5 comprises a display 23, for example a graphic display, and/or an operating device 24. For example, the pneumatic automation device 5 displays one or more flow values and/or pressure values and/or differential pressure values and/or the diagnostic information via the display 23. A user can make a user input via the operating device 24.

Optionally, the pneumatic system 1, in particular the pneumatic automation device 5, is configured to perform an action, a control, and/or a diagnosis based on the pressure value and/or the flow value and/or the differential pressure value.

Preferably, the pneumatic automation device 5, the maintenance assembly 3, and/or the pneumatic system 1 do not include a pressure sensor and/or a flow sensor. In particular, the calculation of the pressure value and the flow value based on the acceleration signal replaces an otherwise necessary measurement of the pressure with a pressure sensor and of the flow with a flow sensor.

The following section will discuss in more detail the exemplary embodiments of the pneumatic automation device 5 shown in FIGS. 2 to 5.

The pneumatic automation device 5 is preferably configured to be a pneumatic filter device 5A. FIG. 2 shows an example of such a filter device 5A. The pneumatic automation device 5 comprises a filter bowl 28 and a filter 29 located in the filter bowl 28. Exemplarily, the filter bowl 28 defines an in particular cylindrical shell space 31 in which the filter 29 is arranged. The filter bowl 28 is, for example, designed as a hollow cylinder. The filter 29 serves to clean compressed air flowing through the filter device 5A. The filter 29 preferably comprises porous material through which the compressed air flows on its way from the compressed air inlet 15 to the compressed air outlet 17 and is thereby cleaned. For example, the filter 29 is hollow cylindrical.

The guide section 25 is expediently part of the filter bowl 28. In particular, the filter bowl 28 defines part of the compressed air channel 16. For example, a section of an inner side of the filter bowl 28 forms a channel wall or a section of a channel wall of the compressed air channel 16, and the compressed air expediently flows along this channel wall (i.e., along the filter bowl 28), for example before the compressed air passes through the filter 29.

Preferably, the electronic arrangement 30 comprising the acceleration sensor 18 is arranged on the filter bowl 28, in particular on an outer side of the filter bowl 28. The acceleration sensor 18 is vibration-coupled to the filter bowl 28. The flow of compressed air from the compressed air inlet 15 to the compressed air outlet 17 causes the filter bowl 28 to vibrate, and the acceleration sensor 18 detects these vibrations and provides the acceleration signal according to the detected vibrations. The computing unit 20 uses the machine learning model 27 to calculate the pressure value and the flow value (and optionally the differential pressure value) based on the acceleration signal. The pressure value describes, for example, a pressure of the compressed air in the compressed air channel 16 at a point before or after the filter 29. The differential pressure value describes, for example, a difference between a pressure of the compressed air in the compressed air channel 16 at a point before the filter 29 and a pressure of the compressed air in the compressed air channel 16 at a point behind the filter 29.

Optionally, the computing unit 20 is configured to determine the wear and/or contamination status of the filter 29 on the basis of the pressure value, the flow value and/or the differential pressure value and to output this information, for example, via the communication interface 22 and/or the display 23.

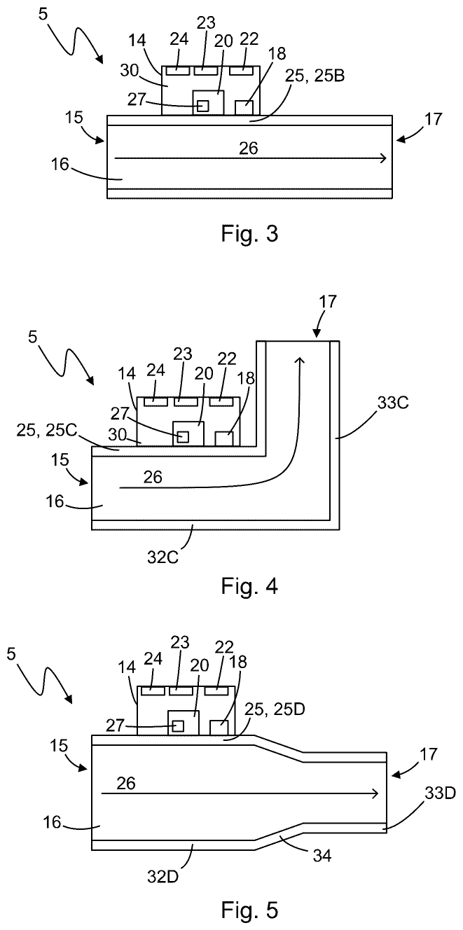

FIG. 3 shows another exemplary embodiment of the pneumatic automation device 5. In this embodiment, the guide section 25 is a pipe section 25B, exemplarily a straight pipe section. The flow 26 of compressed air passes through the inside of the pipe section 25B from the compressed air inlet 15 to the compressed air outlet 17. The electronic arrangement 30 comprising the acceleration sensor 18 is arranged on the outside of the pipe section 25B, so that the acceleration sensor 18 is vibration-coupled to the pipe section 25B and the vibrations of the pipe section 25B caused by the flow 26 can be transmitted to the acceleration sensor 18 and detected by it.

FIG. 4 shows a further exemplary embodiment of the pneumatic automation device 5. In this embodiment, the guide section 25 is an angle section 25C, exemplarily with an angle of 90 degrees. The angle section 25C comprises a first (in particular straight) pipe section 32C and a second (in particular straight) pipe section 33C. The two pipe sections 32C, 33C converge at an angle, for example 90 degrees, and together form the angle section 25C. The flow 26 of compressed air runs inside through the angle section 25C, in particular the first pipe section 32C and the second pipe section 33C, from the compressed air inlet 15 to the compressed air outlet 17. The electronic arrangement 30 comprising the acceleration sensor 18 is arranged on the outside of the angle section 25C, for example the first pipe section 32C, so that the acceleration sensor 18 is vibrationally coupled to the angle section 25C, in particular the first pipe section 32C, and the vibrations of the angle section 25C, in particular the first pipe section 32C, caused by the flow 26 can be transmitted to the acceleration sensor 18 and detected by it. The differential pressure value, which is expediently calculated by the computing unit 20, describes, for example, a difference between a pressure of the compressed air in the compressed air channel 16 in the first pipe section 32C and a pressure of the compressed air in the compressed air channel 16 in the second pipe section 33C.

FIG. 5 shows another exemplary embodiment of the pneumatic automation device 5. In this embodiment, the guide section 25 is a taper section 25D. In the taper section 25D, the diameter of the compressed air channel 16 tapers from a first diameter to a second diameter. The taper section 25D comprises a first (in particular straight) pipe section 32D and a second (in particular straight) pipe section 33D. The second pipe section 33D comprises a smaller diameter than the first pipe section 32D. The two pipe sections 32D, 33D are connected to each other via a connecting section 34. The flow 26 of compressed air passes through the inside of the taper section 25D, in particular the first pipe section 32D, the connecting section 34, and the second pipe section 33D, from the compressed air inlet 15 to the compressed air outlet 17. The electronic arrangement 30 comprising the acceleration sensor 18 is arranged on the outside of the taper section 25D, for example the first pipe section 32D, so that the acceleration sensor 18 is vibrationally coupled to the taper section 25D, in particular the first pipe section 32D, and the vibrations of the taper section 25D, in particular the first pipe section 32D, caused by the flow 26 can be transmitted to the acceleration sensor 18 and detected by it. The differential pressure value, which is expediently calculated by the computing unit 20, describes, for example, a difference between a pressure of the compressed air in the compressed air channel 16 in the first pipe section 32D and a pressure of the compressed air in the compressed air channel 16 in the second pipe section 33D.

1-11. (canceled)

12. A pneumatic automation device comprising a guide section for guiding compressed air, and an acceleration sensor vibration-coupled to the guide section for providing an acceleration signal that represents vibrations of the guide section caused by a flow of the compressed air, further comprising a computing unit configured to calculate, based on the acceleration signal and using a machine learning model, both a pressure value related to the compressed air and a flow value related to the compressed air.

13. The pneumatic automation device of claim 12, wherein the machine learning model maps the acceleration signal to the pressure value and the flow value.

14. The pneumatic automation device of claim 12, wherein the pneumatic automation device is a pneumatic filter device.

15. The pneumatic automation device of claim 14, comprising a filter bowl and a filter located in the filter bowl, wherein the guide section is part of the filter bowl.

16. The pneumatic automation device of claim 12, wherein the guide section is a pipe section, an angle section, or a taper section.

17. The pneumatic automation device of claim 12, wherein the computing unit is configured to calculate a differential pressure value related to the compressed air on the basis of the acceleration signal and using the machine learning model.

18. The pneumatic automation device of claim 12, wherein the acceleration signal comprises one, two or three acceleration signal components, and the computing unit is configured to calculate the pressure value and the flow value using the machine learning model on the basis of the one acceleration signal component, the two acceleration signal components, or the three acceleration signal components.

19. The pneumatic automation device of claim 18, wherein the computing unit is configured to calculate the pressure value and the flow value using the machine learning model exclusively on the basis of the one acceleration signal component, the two acceleration signal components, or the three acceleration signal components.

20. The pneumatic automation device of claim 12, wherein the pneumatic automation device has no pressure sensor and no flow sensor.

21. The pneumatic automation device of claim 12, wherein the computing unit is configured to calculate a frequency spectrum of the acceleration signal and the machine learning model maps the frequency spectrum to the pressure value and the flow value.

22. A maintenance assembly for compressed air conditioning of a pneumatic system, comprising the pneumatic automation device of claim 12.

23. A pneumatic system comprising a compressed air source, the maintenance assembly of claim 22, and a pneumatic machine which is pneumatically connected to the compressed air source via the maintenance assembly.

24. A method of operating the pneumatic automation device of claim 12, comprising the steps of: providing the acceleration signal and calculating, using the machine learning model, the pressure value and the flow value based on the acceleration signal.
